(19) United States
(12) Patent Application Publication
(10) Pub. No.: US 2014/0108144 A1
(43) Pub. Date: Apr. 17, 2014

(54) METHODS AND SYSTEMS FOR USING VOICE INPUT IN DISPLAY ADVERTISEMENTS

(71) Applicant: YAHOO! INC., Sunnyvale, CA (US)

(72) Inventors: Ashutosh KUMAR, Bangalore (IN); Rahul HARI, Bangalore (IN)

(73) Assignee: YAHOO! INC., Sunnyvale, CA (US)

(21) Appl. No.: 13/653,203

(22) Filed: Oct. 16, 2012

(51) Int. Cl. G06Q 30/02

(52) U.S. Cl. 705/14.54

(57) ABSTRACT

Methods and systems for using voice input in display advertisements are disclosed. A default display advertisement is selected based at least in part on targeting criteria. The default advertisement is transmitted to a user device and displayed in a browser application on the user device. A command based on voice input provided by a user for interacting with the default display advertisement is received from the browser application. One or more keywords are extracted from the command, and at least one advertisement for a product is selected based at least in part on the extracted keyword(s). The advertisement is transmitted to the user device, and the default advertisement is modified to display the advertisement.

### BACKGROUND

Behavioral targeting refers to a range of technologies and techniques used by online website publishers and advertisers which allows them to increase the effectiveness of their campaigns by capturing data generated by website and landing page visitors. When a user visits a web site, the pages they visit, the amount of time they view each page, the links they click on, the searches they make and the things that they interact with, and other factors, are used to create a ‘profile’ that links to that visitor's web browser through the use of browser cookies. As a result, site publishers can use this data to create audience segments based upon visitors that have similar profiles. When visitors return to a specific site or a network of sites using the same web browser, those profiles can be used to allow advertisers to position their online ads in front of those visitors who exhibit a greater level of interest and intent for the products and services being offered. On the theory that properly targeted ads will fetch more consumer interest, the publisher (or seller) can charge a premium for these ads over random advertising or ads based on the context of a site.

Behavioral targeting can be used on its own or in conjunction with other forms of targeting based on factors like geography, demographics or contextual web page content. However, this type of cookie-based targeting suffers from some drawbacks. For example, a PC may have cookies stored from multiple users who share that PC, and some accumulated cookies may be entirely irrelevant to some users. In addition, accumulated cookies may be too old, and may not be relevant to a user's imminent interests.

There is a need for improved techniques in determining user interests for a more efficient and engaging targeting experience.

### SUMMARY

Some embodiments of the invention provide systems and methods for using voice input in display advertisements. A default display advertisement may be selected at a server computer based at least in part on one or more targeting criteria. As previously discussed, the targeting criteria may be based on behavioral targeting and/or may be based on factors like geography, demographics or contextual web page content. As used herein, a default advertisement is an advertisement selected based on one or more targeting criteria.

The default advertisement may be transmitted to a user device, wherein the default advertisement is displayed in a browser application on the user device. The advertisement may include one or more of text, audio, and video data, and/or one or more user interface elements (e.g., buttons, links, etc.). The advertisement may include one or more input fields configured to receive voice or speech input. For example, browsers such as Chrome™ by Google of Mountain View, Calif. which support HTML 5 enable speech input fields. In one embodiment, the default advertisement may be for example, an e-catalog.

A command may be received from the browser application, the command may be based on voice or speech input provided by a user (step 216). The voice or speech input may be for interacting with the default display advertisement. In one embodiment, voice or speech input provided by the user may be converted to a text based command by the browser application, and the command may be transmitted to one or more server computers. Browsers such as Chrome™ by Google of Mountain View, Calif. which support HTML 5 enable speech input fields. The user may provide voice or speech input commands such as for example, “show baby products”. In some embodiments, the user may also conduct a search via voice/speech command. For example, the user may provide a command such as, “search for car seats”.

One or more keywords may be extracted from the received command. In one embodiment, at a server computer, one or more keywords may be extracted from the received command. The received command may be a text command converted from the user input voice/speech command. Using the above examples, keywords such as “baby”, and “car seats” may be extracted from the command.

At least one advertisement for a product may be selected based at least in part on the extracted one or more keywords. Using the above example, advertisement(s) related to baby products or car seats may be selected based at least in part on the keywords.

The advertisement may be transmitted to the user device, wherein the default advertisement may be modified or replaced with the received advertisement to display the received advertisement. In one embodiment, the browser application may modify the default advertisement to display the received advertisement. For example, the browser application may modify the default advertisement such that the received advertisement is displayed within part of the original space occupied by the default advertisement. In one embodiment, the browser application may modify the formatting of the default advertisement in order to display the received advertisement. Alternatively, the default advertisement may be replaced with the received advertisement. In one embodiment, the received advertisement may be overlaid on top of the default advertisement.

### BRIEF DESCRIPTION OF THE DRAWINGS

The systems and methods described herein may be better understood with reference to the following drawings and detailed description. Non-limiting and non-exhaustive embodiments are described with reference to the following drawings.

FIG. 1 is an exemplary distributed computer system according to one embodiment of the invention;

FIG. 2 is an exemplary flow diagram illustrating a method according to one embodiment of the invention;

FIG. 3 is an exemplary block diagram according to one embodiment of the invention;

FIG. 4a is a diagram illustrating an exemplary advertisement according to one embodiment of the invention;

FIG. 4b is a diagram illustrating an exemplary advertisement according to one embodiment of the invention;

FIG. 4c is a diagram illustrating an exemplary advertisement according to one embodiment of the invention; and

FIG. 4d is a diagram illustrating an exemplary advertisement according to one embodiment of the invention.

### DETAILED DESCRIPTION

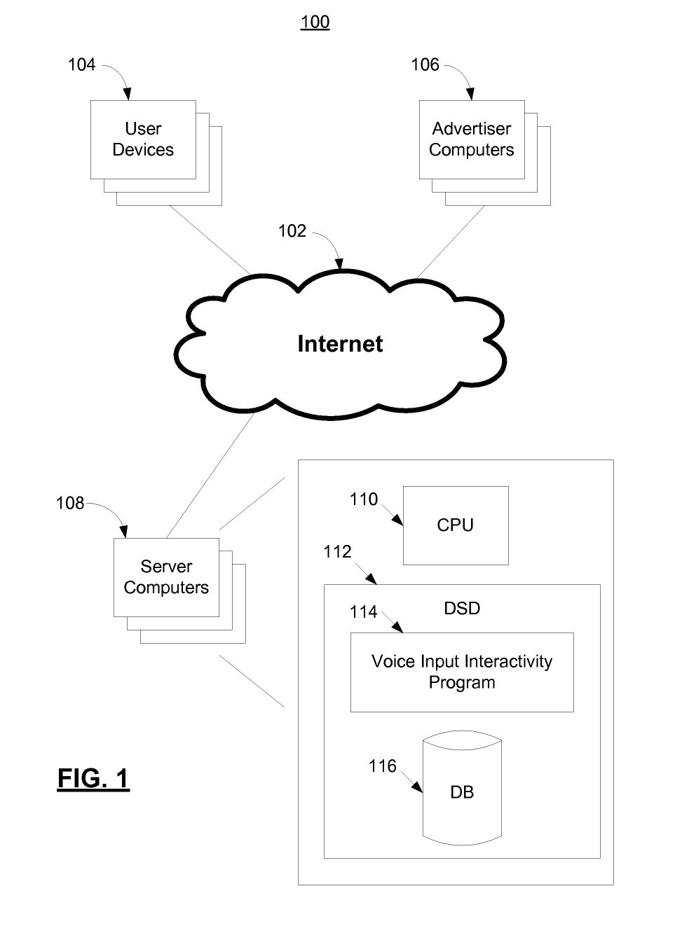

FIG. 1 is a distributed computer system 100 according to one embodiment of the invention. The system 100 includes user devices 104, advertiser computers 106 and server computers 108, all coupled or able to be coupled to the Internet 102. Although the Internet 102 is depicted, the invention contemplates other embodiments in which the Internet is not included, as well as embodiments in which other networks are included in addition to the Internet, including one more wireless networks, WANs, LANs, telephone, cell phone, or other data networks, etc. The invention further contemplates embodiments in which user devices 104 may be or include desktop and laptop PCs, netbooks, as well as, wireless, mobile, or handheld devices such as smartphones, PDAs, tablets, e-readers, etc.

Each of the one or more computers 106 and 108 may be distributed, and can include various hardware, software, applications, algorithms, programs and tools. Depicted computers may also include a hard drive, monitor, keyboard, pointing or selecting device, etc. The computers may operate using an operating system such as Windows by Microsoft, etc. Each computer may include a central processing unit (CPU), data storage device, and various amounts of memory including RAM and ROM. Depicted computers may also include various programming, applications, algorithms and software to enable searching, search results, and advertising, such as graphical or banner advertising as well as keyword searching and advertising in a sponsored search context. Many types of advertisements are contemplated, including textual advertisements, rich advertisements, video advertisements, etc.

As depicted, each of the server computers 108 includes one or more CPUs 110 and a data storage device 112. The data storage device 112 includes a database 116 and a Voice Input Interactivity Program 114.

The Program 114 is intended to broadly include all programming, applications, algorithms, software and other and tools necessary to implement or facilitate methods and systems according to embodiments of the invention. The elements of the Program 114 may exist on a single server computer or be distributed among multiple computers or devices.

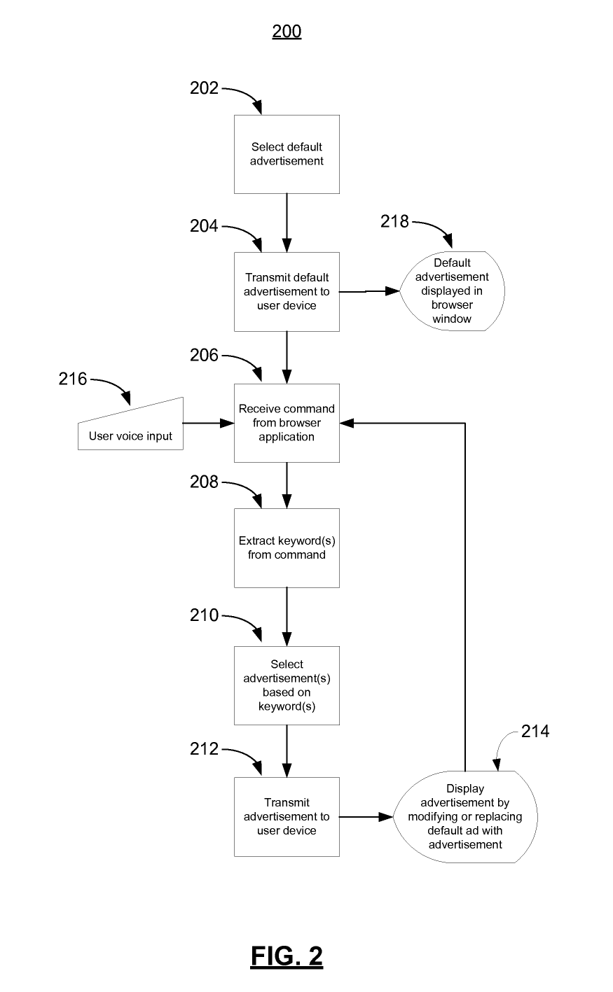

FIG. 2 is a flow diagram illustrating a method 200 according to one embodiment of the invention. At step 202, a default display advertisement may be selected at a server computer based at least in part on one or more targeting criteria. As previously discussed, the targeting criteria may be based on behavioral targeting and/or may be based on factors like geography, demographics or contextual web page content. As used herein, a default advertisement is an advertisement selected based on one or more targeting criteria.

At step 204, the default advertisement may be transmitted to a user device, wherein the default advertisement is displayed in a browser application on the user device. The advertisement may include one or more of text, audio, and video data, and/or one or more user interface elements (e.g., buttons, links, etc.). The advertisement may include one or more input fields configured to receive voice or speech input. For example, browsers such as Chrome™ by Google of Mountain View, Calif. which support HTML 5, enable speech input fields. In one embodiment, the default advertisement may be for example, an e-catalog.

At step 206, a command may be received from the browser application, the command may be based on voice or speech input provided by a user (step 216). The voice or speech input may be for interacting with the default display advertisement. In one embodiment, voice or speech input provided by the user may be converted to a text based command by the browser application, and the command may be transmitted to one or more server computers. Browsers such as Chrome™ by Google of Mountain View, Calif. which support HTML 5, enable speech input fields. The user may provide voice or speech input commands such as for example, “show baby products”. In some embodiments, the user may also conduct a search via voice/speech command. For example, the user may provide a command such as, “search for car seats”.

At step 208, one or more keywords may be extracted from the received command. In one embodiment, at a server computer, one or more keywords may be extracted from the received command. The received command may be a text command converted from the user input voice/speech command. Using the above examples, keywords such as “baby”, and “car seats” may be extracted from the command.

At step 210, at least one advertisement for a product may be selected based at least in part on the extracted one or more keywords. Using the above example, advertisement(s) related to baby products or car seats may be selected based at least in part on the keywords.

At step 212, the advertisement may be transmitted to the user device, wherein the default advertisement may be modified or replaced with the received advertisement to display the received advertisement. In one embodiment, the browser application may modify the default advertisement to display the received advertisement. For example, the browser application may modify the default advertisement such that the received advertisement is displayed within part of the original space occupied by the default advertisement. In one embodiment, the browser application may modify the formatting of the default advertisement in order to display the received advertisement. Alternatively, the default advertisement may be replaced with the received advertisement. In one embodiment, the received advertisement may be overlaid on top of the default advertisement. Steps 206-216 may be repeated as the user provides additional voice or speech input. It should be noted that traditionally, display advertisements have been “pushed” to the user based on decoding of the user profile and/or behavior. Embodiments of the invention allow users to “pull” advertisements for products from within the advertisement itself, without visiting an advertiser's website. In addition, voice interactivity advantageously creates curiosity and engages users to interact with the advertisements, resulting in multiple impressions in a single advertisement.

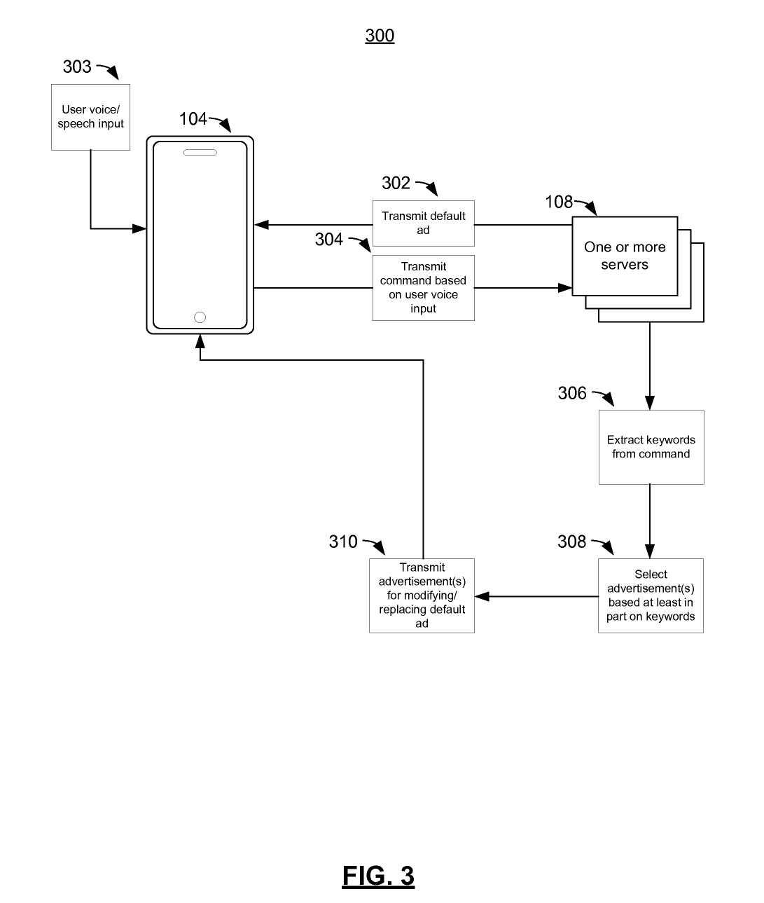

FIG. 3 illustrates a block diagram of a system 300 according to one embodiment of the invention. User device 104, which may be a PC, smartphone, e-reader, tablet, etc. is depicted. As depicted in block 302, one or more servers 108 may transmit a default advertisement to user device 104. As previously discussed, the default advertisement is an advertisement that is selected based at least in part on one or more targeting criteria. The default advertisement may be displayed in a browser application on user device 104. The advertisement may include one or more of text, audio, and video data, and/or one or more user interface elements (e.g., buttons, links, etc.). The advertisement may include one or more input fields configured to receive voice or speech input. For example, browsers such as Chrome™ by Google of Mountain View, Calif. which support HTML 5 enable speech input fields. In one embodiment, the default advertisement may be for example, an e-catalog.

A user may provide voice or speech input, as depicted in block 303. The voice or speech input may be for interacting with the default display advertisement. The user may provide voice or speech input commands such as for example, “show baby products”. In some embodiments, the user may also conduct a search via voice/speech command. For example, the user may provide a command such as, “search for car seats”. In one embodiment, voice or speech input provided by the user may be converted to a text based command by the browser application, and the command may be transmitted to one or more server computers 108 as depicted in block 304.

One or more server computers 108 may extract one or more keywords from the received command as depicted in block 306. The received command may be a text command converted from the user input voice/speech command. Using the above examples, keywords such as “baby”, and “car seats” may be extracted from the command.

One or more server computers 108 may select at least one advertisement for a product based at least in part on the extracted one or more keywords as depicted in block 308. Using the above example, advertisement(s) related to baby products or car seats may be selected based at least in part on the keywords.

The advertisement(s) may be transmitted to user device 104 as depicted in block 310. The default advertisement may be modified or replaced with the advertisement transmitted in block 310. In one embodiment, the browser application may modify the default advertisement to display the advertisement(s) transmitted in block 310. For example, the browser application may modify the default advertisement such that the advertisement(s) transmitted in block 310 is displayed within part of the original space occupied by the default advertisement. In one embodiment, the browser application may modify the formatting of the default advertisement in order to display the advertisement transmitted in block 310. Alternatively, the default advertisement may be replaced with the advertisement transmitted in block 310. In one embodiment, the received advertisement may be overlaid on top of the default advertisement.

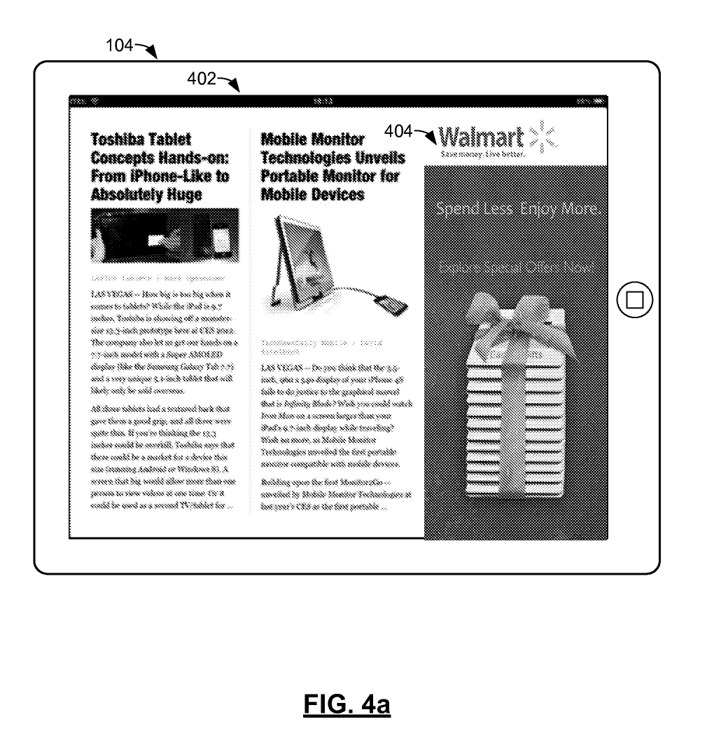

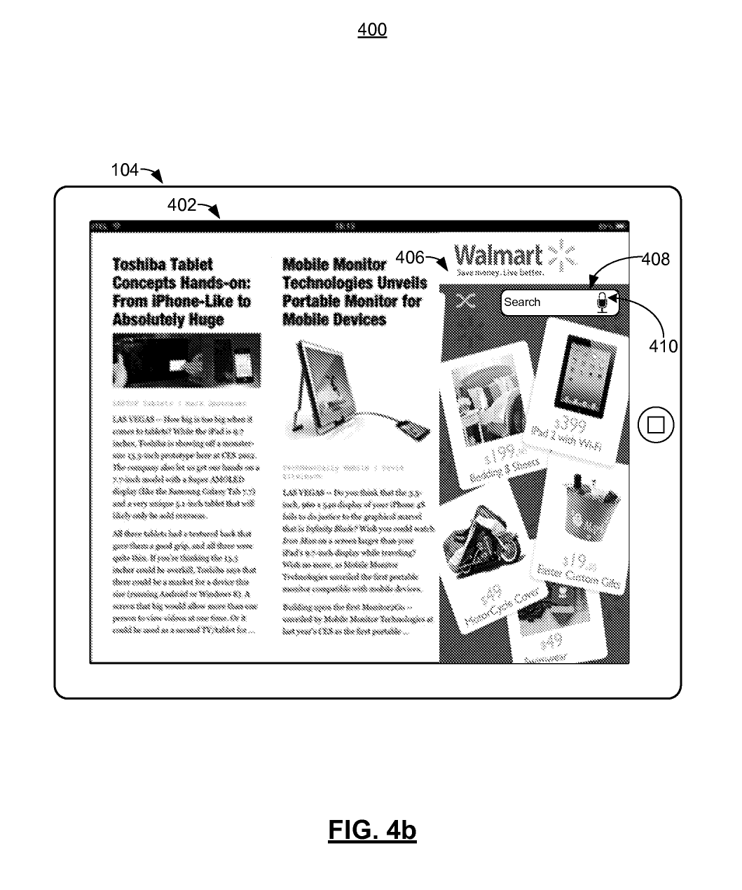

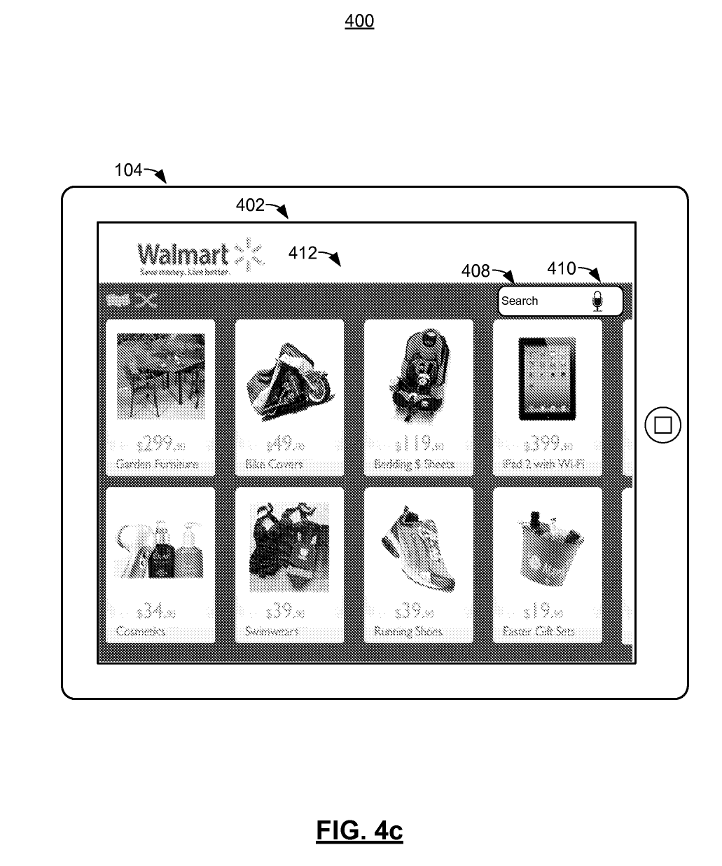

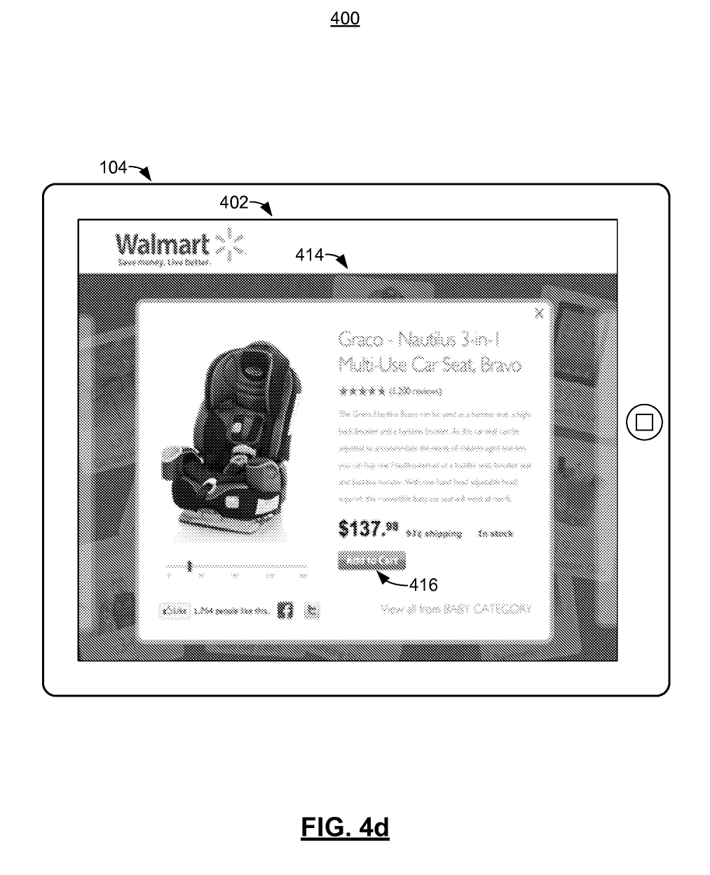

FIGS. 4a-4d illustrate exemplary advertisements in accordance with some embodiments of the invention. Although FIGS. 4a-4d depict a tablet as user device 104, user device 104 may be any device capable of running a web browser application. In one embodiment, the browser application may support voice or speech input. For example, browsers such as Chrome™ by Google of Mountain View, Calif. which support HTML 5, enable speech input fields. As shown in FIG. 4a, user device 104 displays a browser application window 402. A default advertisement 404 is displayed in browser application window 402. Default advertisement 404 may be selected based at least in part on one or more targeting criteria. As previously discussed, the targeting criteria may be based on behavioral targeting and/or may be based on factors like geography, demographics or contextual web page content.

FIG. 4b illustrates default advertisement 406, including an input field 408. The user may provide speech or voice input by for example, clicking or tapping on user interface element 410, and speaking the voice or speech command. Input field 408 may also be used to provide text input (e.g., by typing on a keyboard).

FIG. 4c illustrates one example of modified advertisement 412. The products shown in modified advertisement 412 may have been selected based at least in part on one or more keywords input by the user (e.g., using voice or text input). The user may enter additional commands in field 408 by for example, clicking or tapping on user interface element 410, and speaking the command, or by typing the command on a physical or virtual keyboard (not shown).

FIG. 4d illustrates another example of modified advertisement 414. Advertisement 414 may have been displayed in response to a command such as for example, “more information” when the user was viewing an advertisement for a baby car seat. The user may purchase the advertised product by for example, clicking on user interface element 416. Alternatively, the user may speak a command such as, “purchase” or “add to cart”.

It is to be understood that the above described embodiments are merely illustrative of numerous and varied other embodiments which may constitute applications of the principles of the invention. Such other embodiments may be readily devised by those skilled in the art without departing from the spirit or scope of this invention and it is our intent they be deemed within the scope of our invention.

1. A method comprising:
selecting, at a server computer, a default display advertisement based at least in part on one or more targeting criteria;
transmitting the default advertisement to a user device, wherein the default advertisement is displayed in a browser application on the user device;
receiving a command from the browser application, the command based on voice input provided by a user for interacting with the default display advertisement;
extracting one or more keywords from the command;
selecting at least one advertisement for a product based at least in part on the extracted one or more keywords; and
transmitting the advertisement to the user device, wherein the default advertisement is modified to display the advertisement.

2. The method of claim 1, wherein the default advertisement is an e-catalog advertisement format.

3. The method of claim 1, wherein the voice input comprises voice command for selection of a product category.

4. The method of claim 3, wherein selecting at least one advertisement for a product comprises selecting at least one advertisement for a product corresponding to the product category.

5. The method of claim 1, wherein the voice input comprises a voice command for performing a product search.

6. The method of claim 5, further comprising:
performing the product search based at least in part on the voice command.

7. The method of claim 1, wherein the default advertisement and the advertisement comprise one or more of textual, audio, and video data.

8. The method of claim 1, wherein the default advertisement and the advertisement each comprise at least one user interface element for allowing the user to interact with the default advertisement and the advertisement.

9. The method of claim 1, further comprising:
facilitating a purchase transaction for the product in response to a voice input purchase command provided by the user.

10. A system comprising:
one or more server computers coupled to a network; and
one or more databases coupled to the one or more server computers;
wherein the one or more server computers are for:
selecting a default display advertisement based at least in part on one or more targeting criteria;
transmitting the default advertisement to a user device, wherein the default advertisement is displayed in a browser application on the user device;
receiving a command from the browser application, the command based on voice input provided by a user for interacting with the default display advertisement;
extracting one or more keywords from the command;
selecting at least one advertisement for a product based at least in part on the extracted one or more keywords; and
transmitting the advertisement to the user device, wherein the default advertisement is modified to display the advertisement.

11. The system of claim 10, wherein the default advertisement is an e-catalog advertisement format.

12. The system of claim 10, wherein the voice input comprises voice command for selection of a product category.

13. The system of claim 12, wherein selecting at least one advertisement for a product comprises selecting at least one advertisement for a product corresponding to the product category.

14. The system of claim 10, wherein the voice input comprises a voice command for performing a product search.

15. The system of claim 14, wherein the one or more server computers are further configured for:
performing the product search based at least in part on the voice command.

16. The system of claim 10, wherein the default advertisement and the advertisement comprise one or more of textual, audio, and video data.

17. The system of claim 10, wherein the default advertisement and the advertisement each comprise at least one user interface element for allowing the user to interact with the default advertisement and the advertisement.

18. The system of claim 10, wherein the one or more server computers are further configured for:
facilitating a purchase transaction for the product in response to a voice input purchase command provided by the user.

19. The system of claim 10, wherein the user device is selected from the group comprising a smart phone, an e-reader, a tablet, a desktop PC, and a laptop PC.

20. A non-transitory computer readable medium having stored thereon instructions for causing a computer to execute a method, the method comprising:
selecting a default display advertisement based at least in part on one or more targeting criteria;
transmitting the default advertisement to a user device, wherein the default advertisement is displayed in a browser application on the user device;
receiving a command from the browser application, the command based on voice input provided by a user for interacting with the default display advertisement;
extracting one or more keywords from the command;
selecting at least one advertisement for a product based at least in part on the extracted one or more keywords; and
transmitting the advertisement to the user device, wherein the default advertisement is modified to display the advertisement.
